(19) United States
(12) Patent Application Publication
(10) Pub. No.: US 2020/0364649 A1
(43) Pub. Date: Nov. 19, 2020

(54) METHOD, APPARATUS, AND COMPUTER-READABLE MEDIUM FOR REMOTE MANAGEMENT AND TRACKING OF BAGGAGE ON A TRANSPORTATION CARRIER COMPUTING SYSTEM

(71) Applicant: D2AIRPORT, INC., Wilmington, DE (US)

(72) Inventor: Marcelo de Almeida Madeira, Niteroi (BR)

(21) Appl. No.: 16/410,820

(22) Filed: May 13, 2019

(51) Int. Cl. G06Q 10/08; H04W 4/029

(52) U.S. Cl. CPC G06Q 10/087; G06K 19/06037; H04W 4/029

(57) ABSTRACT

A system, method and computer-readable medium for management and tracking of baggage on an external transportation carrier (TC) computing system, including storing a passenger information record including a passenger identifier generated by the TC computing system, transmitting a request for baggage tags to a transportation carrier (TC) computing system via a TC Application Programming Interface (API), receiving, in response to the request, one or more baggage tags from the TC computing system via the TC API, the one or more baggage tags being linked to the passenger identifier in a data structure of the TC computing system, transmitting the one or more baggage tags to an assistant computing device, receiving a check-in notification from the assistant computing device indicating that the one or more bags were checked in with the TC, and transmitting a baggage update to the TC computing system via the TC API to update the data structure.

### BACKGROUND

Transportation Carriers (TCs), such as Airlines, globally spend approximately $2.3 billion annually to solve problems relating to lost or delayed passenger baggage. In the US the cost is estimated at $620 million. For example, failure to load baggage due to a passenger's late arrival at the airport represents about 16% of the total cost of mishandling baggage. The delayed baggage requires space on subsequent flights, as well as time and resources such as airline crew to handle the baggage.

Lost or delayed baggage can ruin a trip, resulting in the waste of thousands of dollars and time spent attempting to recover the baggage and/or compensation. Even when the baggage is not lost, the process of checking and transporting baggage can be time-consuming and burdensome for passengers. For elderly or disabled passengers, the time and effort required to transport and check bags can be prohibitive.

Another problem with existing baggage check-in systems is that they do not allow for tracking of baggage in form that is accessible or useful to users. While airlines maintain their own systems for baggage tracking, these systems rely on periodic scanning of baggage at different locations and passengers are unable to track the status and location of their own baggage on these systems.

As discussed above, airlines maintain their own baggage tracking and management systems. However, each of these internal systems is a closed system. Any improvement in the technology for baggage management and tracking is therefore required to interface with the airline systems. However, there is currently no way to interface with internal baggage tracking systems across disparate airlines and to leverage that interface in order to effect improvements in the technology for checking in, managing, and tracking baggage.

Accordingly, improvements are needed in hardware and software interfaces for checking in, managing, and tracking baggage on a transportation carrier (TC) computing system.

### BRIEF DESCRIPTION OF THE DRAWINGS

FIG. 1 illustrates a flowchart for management and tracking of baggage on a TC computing system according to an exemplary embodiment.

FIG. 2 illustrates an example of a passenger information record according to an exemplary embodiment.

FIG. 3 illustrates a flowchart for storing a passenger information record according to an exemplary embodiment.

FIG. 4 illustrates a data flow diagram for storing a passenger information record according to an exemplary embodiment.

FIG. 5 illustrates a data flow diagram corresponding to the process for requesting and receiving baggage tags according to an exemplary embodiment.

FIGS. 6A-6E illustrate the process for baggage pickup and dropoff and the TC location according to an exemplary embodiment.

FIG. 7 illustrates a data flow diagram for transmitting a baggage update according to an exemplary embodiment.

FIG. 8 illustrates a flowchart for transmitting a baggage update to the TC computing system via the TC API for a batch check-in notification according to an exemplary embodiment.

An example of batch processing of a check-in notification is shown in FIG. 9.

FIG. 10 illustrates a flowchart for processing baggage retrieval according to an exemplary embodiment.

FIG. 11 illustrates a flowchart for location tracking of baggage by the baggage management system according to an exemplary embodiment.

FIG. 12 illustrates a data flow diagram of the process for querying baggage location according to an exemplary embodiment.

FIG. 13 illustrates a baggage management system for management and tracking of baggage on an external TC computing system according to an exemplary embodiment.

### DETAILED DESCRIPTION

While methods, apparatuses, and computer-readable media are described herein by way of examples and embodiments, those skilled in the art recognize that methods, apparatuses, and computer-readable media for management and tracking of baggage on an external TC computing system are not limited to the embodiments or drawings described. It should be understood that the drawings and description are not intended to be limited to the particular forms disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” “includes”, “comprise,” “comprises,” and “comprising” mean including, but not limited to.

As discussed above, improvements are needed in hardware and software interfaces for checking in, managing, and tracking baggage on a transportation carrier (TC) computing system. Although the present disclosure makes frequent reference to airlines, it is understood that the TC can be a carrier involved in other forms of transport, such as railroads, buses, ferries, cruise ships, etc. Applicant has discovered novel methods, apparatuses, and computer-readable media for management and tracking of baggage on a TC computing system that overcomes many of the existing problems in the technology.

The technology platform disclosed in this application interfaces with disparate TC computing systems and allows for real-time monitoring of baggage location by both a TC and a passenger. Additionally, the disclosed technology platform enables improvements in baggage management and tracking technology, including the ability to pick-up baggage from a passenger's home, interface with TC computing systems to retrieve any required baggage tags or identifiers, and dynamically update both the TC and the passenger upon baggage check-in prior to departure. The present system also include logistics features to enable efficient collection and deposit of baggage from multiple passengers, such as routing systems to generate efficient routes of pickup depending upon passenger home address, flight time, airport. As discussed in greater detail below, the present system also capitalizes on efficiencies gained through batch processing. Rather than requiring a separate transaction or message for each checked-in item of baggage, the technology platform disclosed herein can batch baggage check-in messages across different passengers depending upon flight and time, resulting in efficiency improvements for TC computing systems.

The novel methods, apparatuses, and computer-readable media disclosed herein overcome the technological problems posed by walled-off TC baggage tracking systems through a platform containing number of specialized Application Programming Interfaces (APIs) configured to interface with disparate TC computing systems, with user-facing applications and websites, and with additional technology providers such as a location tracking computing systems. This platform provides an extensible interface layer between TCs, such as airlines, and passengers that can be leverage to provide additional services to both passengers and TCs while enabling passengers to access TC computing systems as required for baggage check-in and tracking.

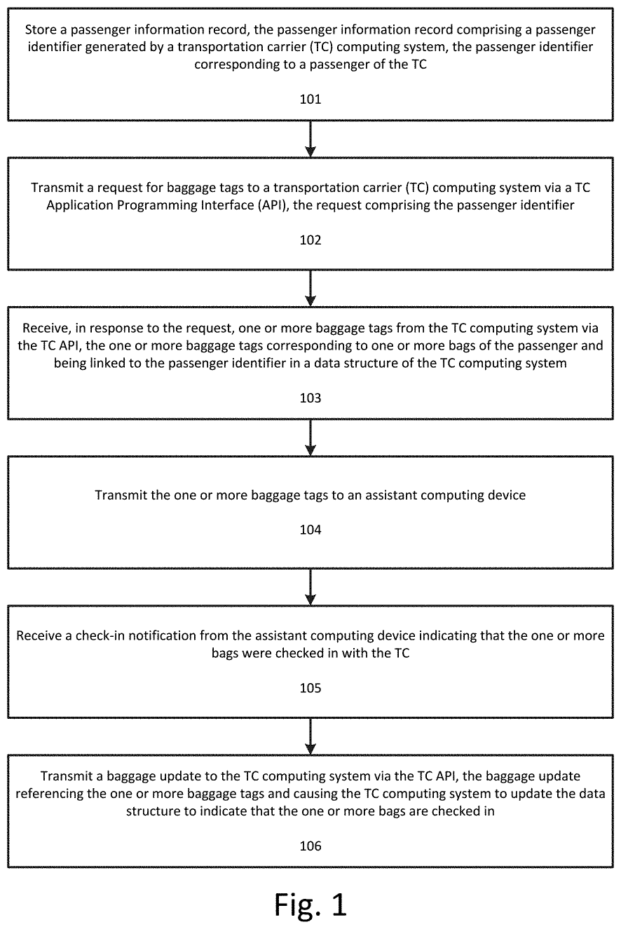

FIG. 1 illustrates a flowchart for management and tracking of baggage on a TC computing system according to an exemplary embodiment. The steps performed in the flowchart of FIG. 1 are performed by a baggage management system that is external to the TC computing system, as discussed below.

At step 101 a passenger information record is stored. The passenger information record includes a passenger identifier generated by the TC computing system, the passenger identifier corresponding to a passenger of the TC. This passenger identifier is utilized when communicating with the TC computing system in order to access and update information corresponding to a particular passenger, including information pertaining to the passenger's baggage.

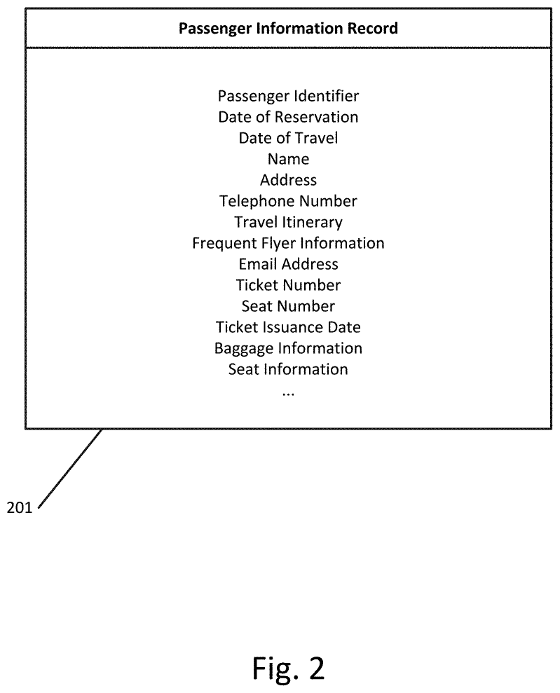

FIG. 2 illustrates an example of a passenger information record 201 according to an exemplary embodiment. As shown in FIG. 2, the passenger information record 201 can include the passenger identifier, flight details of the passenger, residential and biographical information, and other information used for verification of the passenger. Of course, passenger information record 201 is shown for illustration only, and the passenger and baggage information stored on the baggage management system can be stored in a variety of different formats, such as special-purpose data object, database tables, etc. For example, the passenger information record can be one or more rows of a database table.

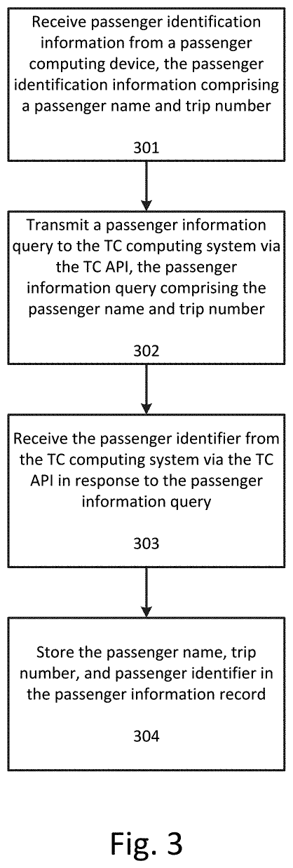

As discussed above, the passenger identifier is generated by the TC computing system and then subsequently stored in the passenger information record on the baggage tracking system. The step of storing the passenger information record can therefore include a step of querying the TC computing system. FIG. 3 illustrates a flowchart for storing a passenger information record according to an exemplary embodiment.

At step 301 passenger identification information is received from a passenger computing device, the passenger identification information including a passenger name and trip number. The passenger can input this information on an application or web page running on their computer or mobile device when registering or signing up for the baggage management system. For example, for airline flights, the passenger can enter their name and their flight number, as well as the airline.

At step 302 a passenger information query is transmitted to the TC computing system via a TC Application Programming Interface (API), the passenger information query including the passenger name and trip number. The TC API is a specialized API that is configured to interface with the computing systems of the TC (for example, an airline carrier) in order to exchange information, submit queries, or provide updates.

The TC computing system itself can be selected from a plurality of TC computing systems based on the passenger provided information. For example, if the passenger specifies a particular airline, then the TC computing system and API for that airline is loaded. This process can include receiving a TC identifier from a passenger computing device and selecting the TC API for communications with the TC from a plurality of TC APIs based at least in part on the received TC identifier.

At step 303 the passenger identifier is received from the TC computing system via the TC API in response to the passenger information query. This passenger identifier is the identifier generated by the TC to track the passenger and their corresponding flight information. The passenger identifier can be generated, for example, when the passenger books their trip. The TC computing system can look up the passenger record in its internal system using the provided passenger name and trip number and provide the TC generated passenger identifier back to the baggage management system. The TC computing system can additionally provide one or more other values of data fields shown in the passenger information record 200 of FIG. 2.

At step 304 the passenger name, the trip number, and the passenger identifier are stored in the passenger information record on the baggage management system computer(s). Of course, this step can be performed in multiple stages as the pertinent information is received. For example, the passenger name and the trip number can be stored in the passenger information record when received from the passenger computing device and the passenger identifier can be stored when received from the TC computing system.

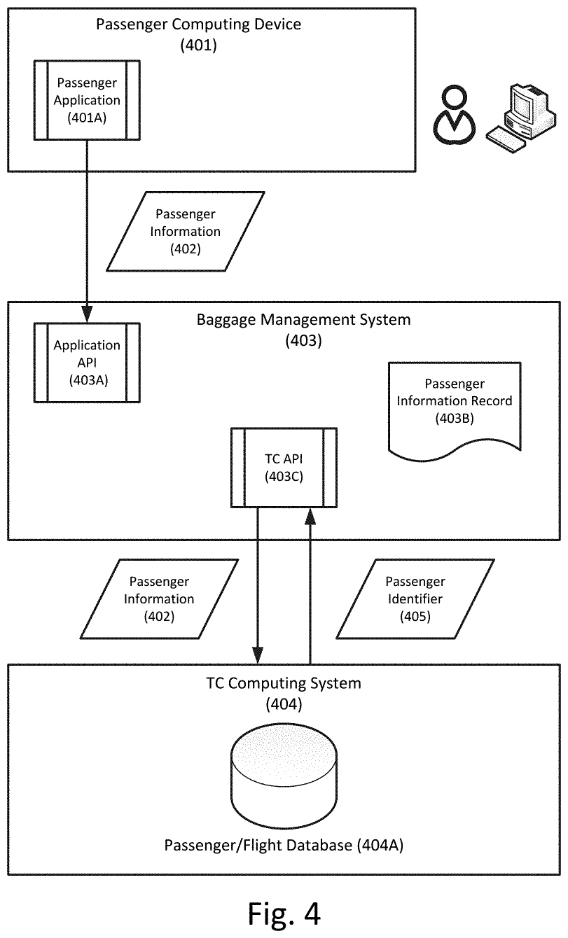

FIG. 4 illustrates a data flow diagram for storing a passenger information record according to an exemplary embodiment. As shown in FIG. 4, a passenger application 401A executing on the passenger computing device 401 transmits the passenger information 402 to the baggage management system 403. The passenger computing device 401 can be a laptop computer, mobile device, or other computing device. Similarly, the passenger application 401A can be a mobile application, a desktop application and/or a browser-based application.

This step can be performed when a passenger registers for the baggage management system. For example, a passenger can check-in to a flight, select their baggage options, and then register for the baggage management system by providing their biographic and flight details to the baggage management system.

The passenger information 402 is received by a passenger application API 403A on the baggage management system 403. The passenger application API can be a RESTful API and is configured to exchange information and communications between the baggage management system 403 and passenger applications 401A executing on the passenger computing device 401.

Optionally, the passenger information 402 can be used at this stage by the baggage management system 403 to create and/or update the passenger information record 403B. In this case, the passenger information record 403B will initially contain only the information provided by the passenger computing device 401, such as the passenger name and flight details.

The baggage management system 403 then transmits the passenger information 402 to the TC computing system 404 via a TC API specialized for communications with that particular TC. For example, airline carriers can utilize a different API and the baggage management system can determine the appropriate API based upon the flight details provided in the passenger information 402. Although not shown in the figure, the TC computing system 404 can also include a specialized API to allow it to communicate with the baggage management system 403.

The TC computing system 404 then performs a lookup in a passenger and/or flight database 404A using the received passenger information to retrieve additional details about the passenger and/or flight, such as the passenger identifier 405, frequent flier number, biographical details, flight times, etc. The passenger identifier 405 and any other information retrieved based on the lookup operation is then transmitted back to the baggage management system 403 via the TC API 403C. The baggage management system 403 then can then create the passenger information record 403B and populate it with the information received from the passenger computing device 401 and the TC computing system 404. Alternatively, if the passenger information record 403B was previously created, the baggage management system 403 can update the passenger information record 403B with the new information (including the passenger identifier 405) received from the TC computing system 404.

Returning to FIG. 1, at step 102 a request for baggage tags is transmitted to the TC computing system via a TC Application Programming Interface (API), the request comprising the passenger identifier. This request can originate at a computing device of an assistant/employee of the baggage management system (“assistant computing device”) and then be passed to the baggage management system, which itself transmits the request or a modified version of the request to the TC computing system. For example, the assistant computing device can transmit a baggage tag request including a passenger name and trip number. The baggage management system can then use this information to look up the passenger identifier in the passenger information record and transmit a baggage tag request including the passenger identifier to the TC computing system.

As discussed in greater detail below, the assistant computing device can be a mobile device and can be utilized by an assistant who is tasked with picking up the passenger's baggage prior to their flight/trip, transporting the baggage to the flight/trip departure location, and checking the baggage in at the appropriate location.

At step 103 one or more baggage tags are received in response to the request from the TC computing system via the TC API. The one or more baggage tags correspond to one or more bags of the passenger and are linked to the passenger identifier and/or a passenger record in a data structure of the TC computing system.

Upon purchase of the tickets and/or check-in by the passenger with the TC, the passenger can specify the number of bags that they would like to check. This information can then be utilized by the TC to create a passenger record and identifier for the passenger. The passenger identifier is then linked in memory to the number of bags the passenger has selected. For example, the TC computing system can store an array of baggage tag identifiers (alphanumeric identifiers corresponding to the baggage tags) for a passenger, where the size of the array corresponds to the number of checked bags. The actual baggage tags for these bags can then be generated at the time of check-in by the passenger and stored on the TC computing system. The baggage tags can also be dynamically generated when they are requested, i.e., when the baggage tag request is received from the baggage management platform.

The baggage tags themselves can take a number of forms, such as bar codes (one dimensional bar codes), two-dimensional bar codes (known as QR codes), an alphanumeric sequence of characters, etc. In the scenario where the baggage tags are QR codes or other graphical objects, the TC computing system can store baggage tag identifiers corresponding to each baggage tag in order to link baggage tags with specific passengers. For example, each QR code baggage tag can have a corresponding alphanumeric baggage tag identifier.

The baggage tags can be linked to the passenger record and/or the passenger identifier in a number of ways. For example, the TC computing system can store baggage tag identifiers corresponding to baggage tags in a table, with each row of the table corresponding to a different passenger. The TC computing system can also utilize special purpose objects corresponding to passengers and define a dynamic array of baggage tag objects. Many variations are possible and these examples are not intended to be limiting.

At step 104 the one or more baggage tags are transmitted to an assistant computing device. As discussed earlier, the request for baggage tags can be initially received by the baggage management system from an assistant computing device. After the baggage tags are received from the TC computing system, they can then be transmitted back to the assistant computing device. As discussed in greater detail below, this allows the assistant to print the baggage tags and physically attach them to the bags the passenger would like to check in.

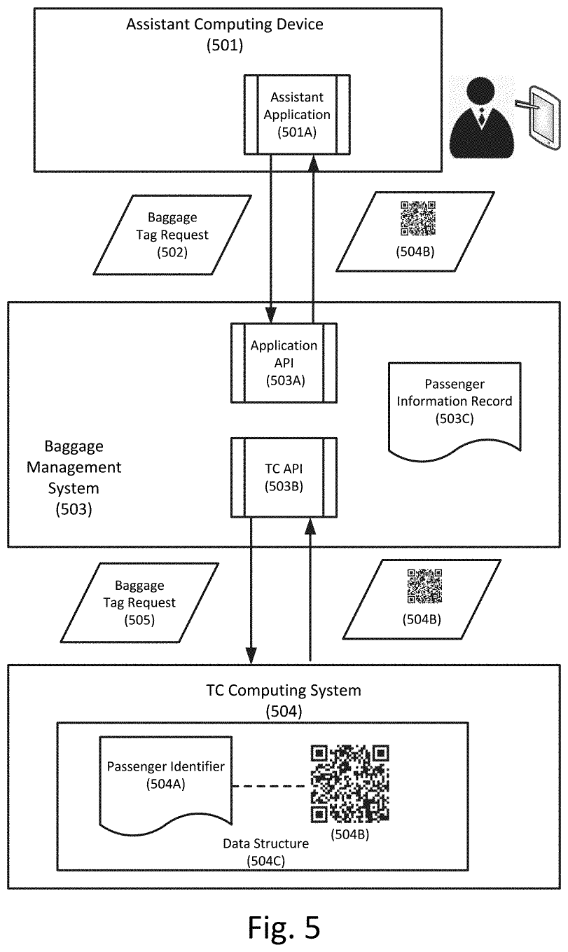

FIG. 5 illustrates a data flow diagram corresponding to the process for requesting and receiving baggage tags according to an exemplary embodiment. As shown in FIG. 5, an assistant application 501A executing on an assistant computing device 501 transmits the baggage tag request 502 to the baggage management system 503. The assistant can transmit the request once they have arrived at the residence/hotel of the passenger and has confirmed the identity of the passenger. For example, the passenger can be required to present a code to the assistant which the assistant can transmit to the baggage management system to confirm the passenger's identity.

An assistant application API 503A of the baggage management system 503 receives the baggage tag request 502. If the request 502 includes only a passenger name or identifying information other than the passenger identifier, then the baggage management system 503 can perform a lookup of the passenger identifier within the passenger information record 503C based upon the received information. Otherwise, if the baggage tag request 502 includes the passenger identifier, the baggage management system can generate and transmit its own baggage tag request 505 to the TC computing system 504 via a TC API 503B.

The TC computing system 504 receives the baggage tag request 505 and performs a lookup within data structure 504C using the passenger identifier to locate a baggage tag 504B that is linked to the passenger identifier 504A. Alternatively, the TC computing system 504 can generate baggage tag dynamically, in response to requests. In this case, the TC computing system can receive the passenger identifier 504A within the baggage tag request 505 and then generate the corresponding baggage tag 504B. The corresponding baggage tag 504B can then be linked to passenger identifier 504A within data structure 504C.

The linking between the passenger identifier 504A and the baggage tag 504B within the corresponding data structure 504C can take a variety of forms. For example, the data structure can be a database table and the passenger identifier 504A and a baggage tag identifier can be stored in a single row. The baggage tag identifier can be, for example, an alphanumeric representation of baggage tag 504B, a memory address of the baggage tag 504B, a hash value computed on the baggage tag, or any other value that links to the baggage tag 504B. In another example, the passenger identifier 504A can be part of a data structure that contains a pointer to the image of the baggage tag 504B. Many variations are possible and these examples are not intended to be limiting.

The TC computing system then returns the linked baggage tag 504B to the baggage management system 503 via TC API 503B. The baggage management system 503 can optionally store the baggage tag 504B within passenger information record 503C, which is accessible to passengers via a separate API, as discussed earlier. The baggage management system 503 then forwards this baggage tag to the assistant application 501A on the assistant computing device 501 via assistant application API 503A. The baggage tag is then accessible to the assistant, who can print out the tag and affix it to the passenger's baggage upon pickup and prior to check-in.

Returning to FIG. 1, at step 105 a check-in notification is received from the assistant computing device indicating that the one or more bags were checked in with the TC. The check-in notification is transmitted by the assistant via the assistant computing device upon successful delivery of the baggage to the appropriate location based upon the passenger's trip information. For example, if the passenger is an airline passenger, the assistant will transport the baggage to the appropriate terminal of the airport (using information looked up from the passenger's information record) and deposit the baggage on the appropriate conveyer belt corresponding to the passenger's flight. This process is performed independent of the passenger's involvement, allowing the passenger to focus on making their flight and not on transportation and check-in of their baggage.

The check-in notification can include information sufficient to identify the passenger and/or the baggage, as well as a flag or value indicating that the baggage corresponding to the passenger or the baggage tag/identifier was checked in. For example, the check-in notification can include the baggage tag and a Boolean variable “checkedIn” that is set to true. The check-in notification can additionally or alternatively include the passenger identifier and the Boolean variable “bagsChecked” that indicates that all bags linked to that passenger identifier were successfully checked in.

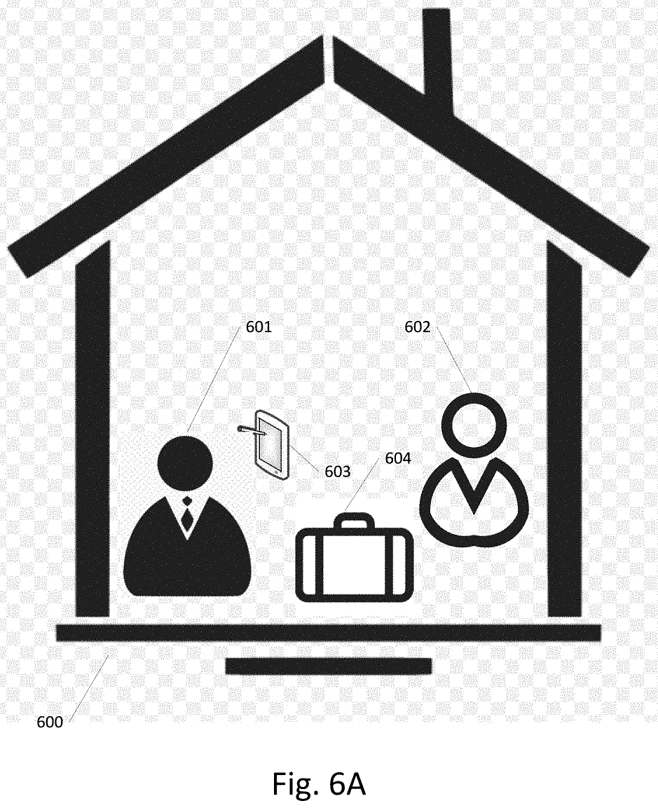

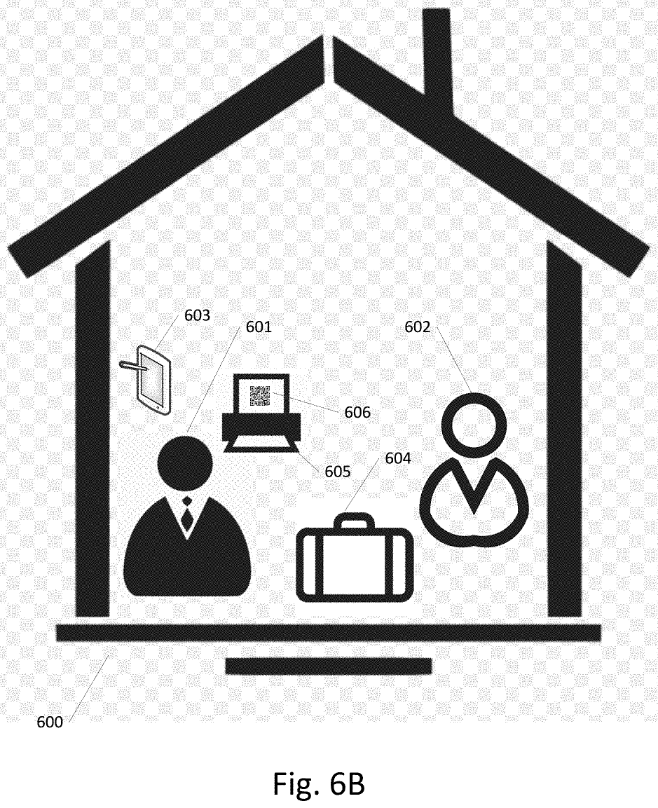

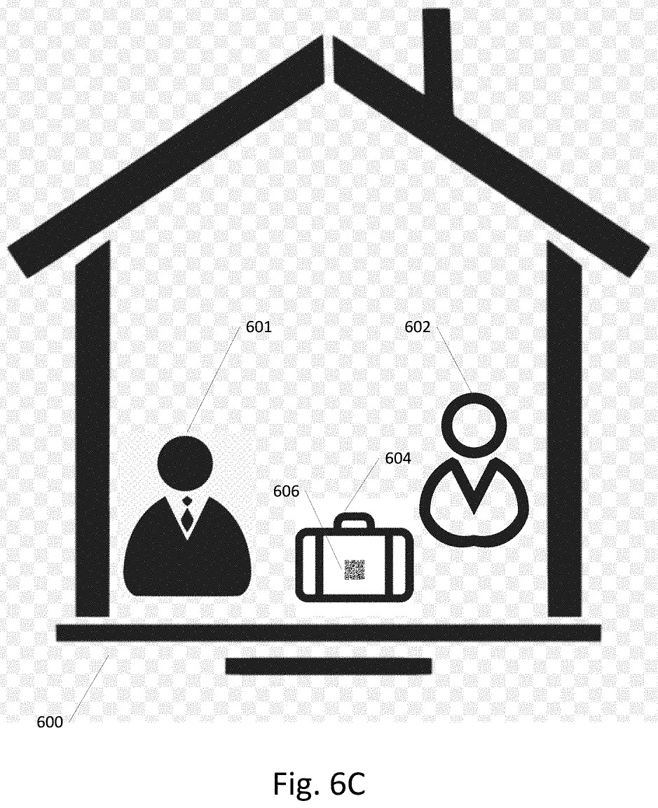

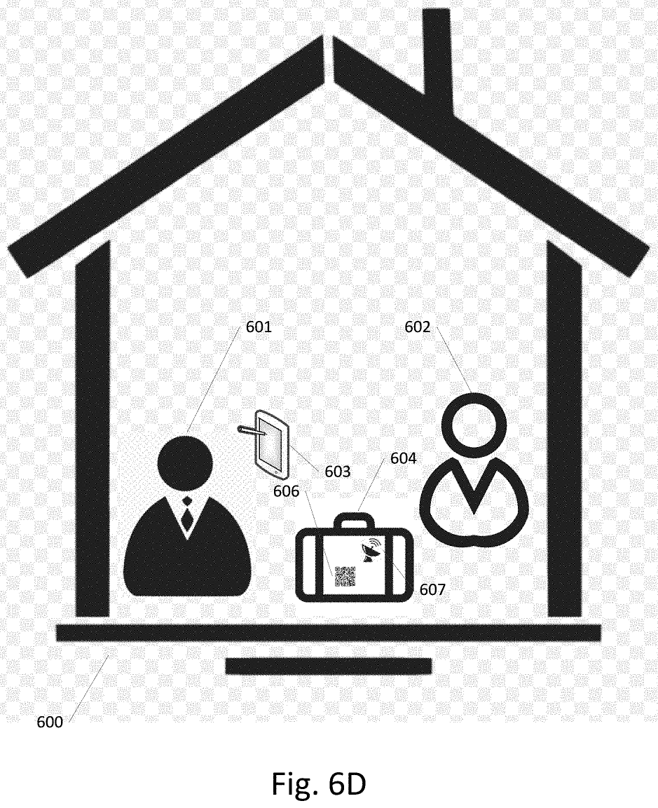

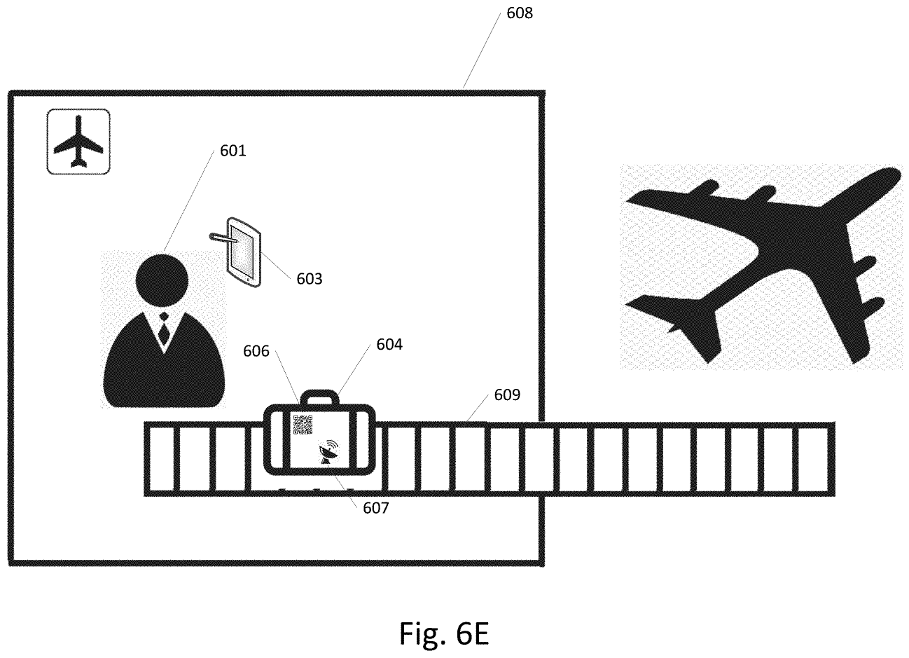

FIGS. 6A-6E illustrate the process for baggage pickup and dropoff and the TC location according to an exemplary embodiment. As shown in FIG. 6A, an assistant arrives at the residence/hotel 600 of the passenger 602 for baggage pickup. As discussed further below, when making multiple pickups of multiple bags from different customers, a scheduler and a route optimizer can be utilized to optimize the pickup route for a particular driver so as to minimize the total driving time and/or driving distance.

The assistant 601 can optionally confirm the identity of the passenger 602 and/or verify to the baggage management system that they have arrived by entering a code into their assistant computing device 603 (which can be, for example, a mobile device). This code can be provided by the baggage management system to the passenger 602 beforehand, such as via a passenger application or via text message, phone call, or email. When the assistant 601 arrives at the residence 600, the passenger 602 can provide the code to the assistant 601, who enters it into their assistant computing device 603. The assistant computing device 603 then transmits the code to the baggage management system, which verifies that the assistant 601 has arrived and proceeds to the next step of the baggage pickup process.

The assistant 601 can then examine the baggage 604 of the passenger 602 and request baggage tags for the baggage 604 through their computing device 603. As discussed earlier, the baggage tag request is routed through the baggage management system to the airline and the corresponding baggage tag is again routed through the baggage management system to the assistant computing device 603. Optionally, the baggage tag request can be transmitted automatically upon successful verification that the assistant 601 has arrived.

Turning to FIG. 6B, the assistant computing device 603 receives an electronic version of the baggage tag from the baggage management system, which itself receives the baggage tag from the TC computing system. The assistant 601 can then use a mobile printer 605 (such as a thermal printer) that is communicatively coupled to the assistant computing device 603 to print a physical copy of the baggage tag 606. As shown in FIG. 6C, the assistant 601 can then affix the baggage tag 606 to the baggage 604 of the passenger 602.

As discussed in greater detail below, the disclosed baggage management system also enables location tracking of baggage. In order to facilitate this process, location tracking devices can be attached to the baggage upon pickup. FIG. 6D illustrates an example of the assistant 601 attaching a location tracking device 607 to the baggage 604 of the passenger 602. The location tracking device 607 can be, for example, a GPS based device that broadcasts its coordinates periodically or continuously or that responds with its coordinates when queried by another computing device. The location tracking device can include a transceiver and the appropriate physical hardware (such as processors, memory, and software instructions encoded on the memory) to carry out these functions.

The assistant 601 also enters an identifier of the location tracking device 607 into the assistant computing device 603 for transmission to the baggage management system. This identifier can be, for example, a serial number of the location tracking device 607. This identifier can subsequently be utilized by the baggage management system to query or lookup the location coordinates of baggage 604. Identifiers of location tracking devices can be stored in the passenger information record for that passenger in the baggage management system. Optionally, the assistant can first scan an identifier of the location tracking device 607 (using, for example, a camera on assistant computing device 603) and then affix it to the baggage 604. The scanned identifier can then be transmitted to baggage management system and used to update the passenger information record with the corresponding location tracking device serial numbers.

Optionally, after bags have been picked up from the passenger residence, the assistant or other assistants can perform security scanning of the bags using scanners (such as X-ray scanners) on board a vehicle used to make the pickups. For example, an X-ray scanner can be placed with a van used to make pickups.

FIG. 6E illustrates the baggage 606 drop-off process at the TC location. In the example of FIG. 6E, the TC is an airline carrier. The assistant 601 can look up the appropriate baggage drop location 608 using the passenger information record and flight details. At baggage drop location 608 the baggage 604 including the baggage tag 606 and the location tracking device 607 is place on the appropriate conveyer belt or other drop spot 609. The baggage is then transported (either automatically or manually) by the airline staff and airline systems to the appropriate location for loading onto the passenger's plane.

Upon drop off of the baggage 604 at the drop spot 609, the assistant 601 transmits a check-in notification to the baggage management system using the assistant computing device 603. The assistant computing device 603 can execute an assistant application that allows the assistant to easily select the appropriate passengers/bags and transmit the check-in notification. For example, the interface of the assistant application can include a drop down list or checkboxes corresponding to all bags/passengers, allowing the assistant 601 to simply check the relevant bags/passengers and then click a button that sends the check-in notification to the baggage management system.

Because the present system is integrated with TC computing systems via a specialized API, it is not necessary for TC staff to scan baggage tags or update their internal systems. Rather, this updating is performed by the baggage management system via the TC API. Turning back to FIG. 1, at step 106 a baggage update is transmitted to the TC computing system via the TC API.

The baggage update references the one or more baggage tags. For example, the baggage update can include baggage tag identifiers corresponding to the baggage tags of the checked baggage. The baggage update can also include a passenger identifier that can be used by the TC computing system to lookup the baggage tags. Additionally, the baggage update can include electronic versions of the baggage tags within the baggage update.

The baggage tag update causes the TC computing system to update its internal data structures to indicate that the one or more bags are checked in. For example, the baggage tag update can be structured as a database update command, with field values corresponding to whether a bag is checked in being set to “True” using the baggage tag or baggage tag identifier as a lookup key for the appropriate records. Alternatively, the baggage tag update can simply include a variable or message indicating that the corresponding bags were checked in, and the TC computing system can then lookup the appropriate baggage tags and update its own internal data structures based upon the receipt of this message.

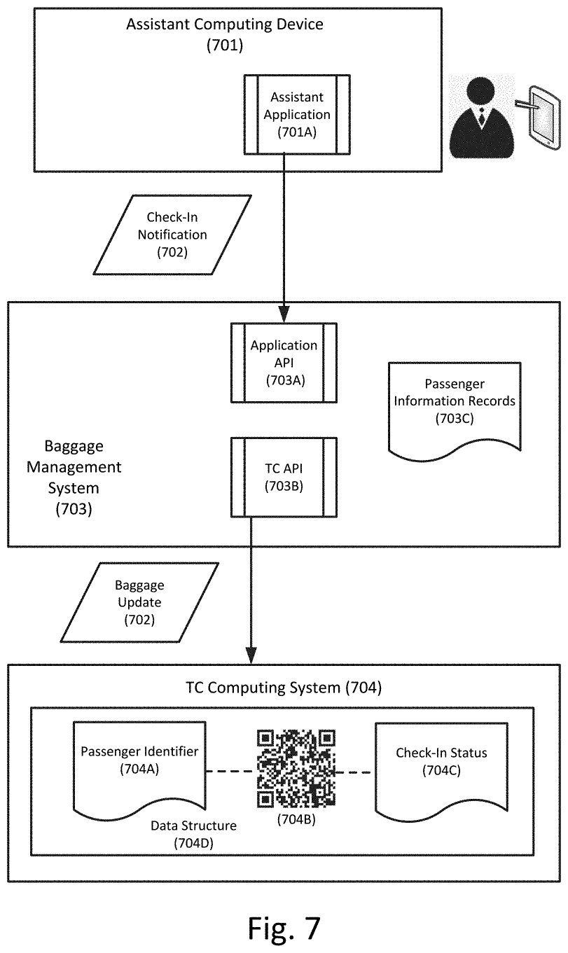

FIG. 7 illustrates a data flow diagram for transmitting a baggage update according to an exemplary embodiment. As shown in FIG. 7, the assistant first transmits a baggage check-in notification 702 from the assistant application 701A on the assistant computing device 701.

This check-in notification 702 is received by the assistant application API 703A of the baggage management system 703. The check-in notification 702 can optionally be a batch notification, corresponding to multiple different bags associated with multiple different passengers. If this is the case, the baggage management system can look up a passenger corresponding to each bag using passenger information records 703C. Alternatively, if the check-in notification contains only the identifiers/names of passengers whose bags have been checked in, then the baggage management system 703 can use passenger information records 703C to look up the appropriate baggage tags or baggage tag identifiers.

The baggage management system 702 then sends a baggage update 702 to the TC computing system 704. As discussed earlier, the baggage update 702 references the baggage tags of the bags that have been checked in. The baggage update 702 can include electronic versions of the baggage tags, baggage tag identifiers, passenger identifiers of passengers whose bags have been checked, or any other information that allows the TC computing system 704 to identify the corresponding baggage tags.

The baggage update 702 then causes the TC computing system 704 to update an internal data structure 704D to indicate that the corresponding bags have been checked-in. In the example of FIG. 7, this includes updating a check-in status variable 704C that is linked to the baggage tag 704B and the passenger identifier 704A within the data structure 704D. As discussed earlier, the relevant data structure and this updating step can take a variety of different forms. For example, the data structure 704D can be a SQL database table and the updating can include changing the value of a “Check-In Status” column in a row corresponding to the passenger identifier 704A and baggage tag 704B.

As discussed earlier, the check-in notification received by the baggage management system can be a batch communication, meaning it references multiple different bags and/or passengers. This can be useful from a practical and network resources standpoint, as sending a single message containing all checked-in bags is more efficient than scanning baggage tags and sending multiple updates (as is done by airlines). Additionally, the assistant can then deposit all bags corresponding to a particular flight and time at the appropriate location and send a single check-in notification, as opposed to sending a separate notification for each bag/passenger.

When the check-in notification is a batch check-in notification, indicating that a plurality of bags associated with a plurality of passengers were checked in, the baggage management system can perform additionally processing on the batch check-in notification as part of the step of transmitting a baggage update to the TC computing system.

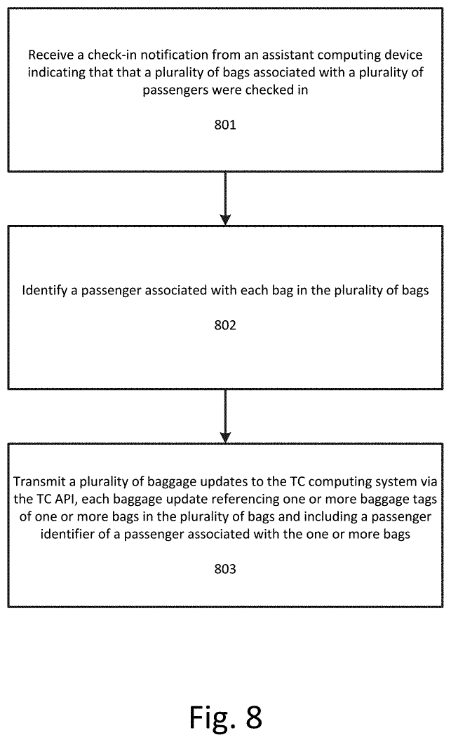

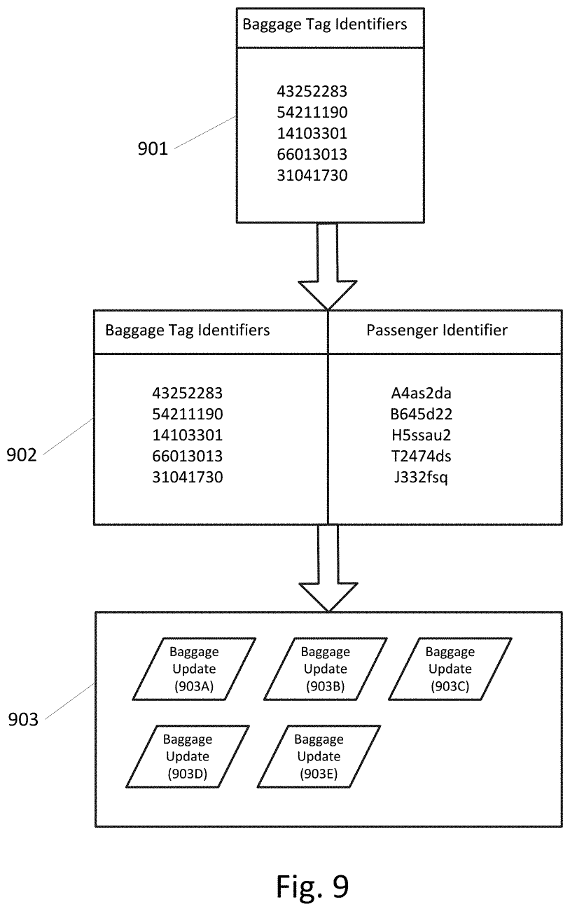

FIG. 8 illustrates a flowchart for transmitting a baggage update to the TC computing system via the TC API for a batch check-in notification according to an exemplary embodiment. The steps shown in FIG. 8 are performed by the baggage management system.

At step 801 a check-in notification is received from an assistant computing device indicating that that a plurality of bags associated with a plurality of passengers were checked in. This batch check-in notification is discussed in detail above, and can include, for example, a list of baggage tags of all checked bags.

At step 802 a passenger associated with each bag in the plurality of bags is identified. This identification step can vary slightly depending on the information that is provided in the check-in notification, but will involve the baggage management system searching through its passenger information records to identify a passenger corresponding to each bag in the checked bags. For example, if baggage tag identifiers are provided in the check-in notification, then the baggage management system will search passenger information records for passenger identifiers of passengers linked to those baggage tag identifiers.

At step 803 a plurality of baggage updates are transmitted to the TC API, with each baggage update referencing one or more baggage tags of one or more bags in the plurality of checked-in bags and including a passenger identifier of a passenger associated with the one or more bags. These baggage updates cause the TC computing system to update a plurality of data structures to indicate that the plurality of bags were checked in.

The baggage updates do not need to be sent as a separate communications and can be contained in a single message. For example, a single message containing a table of baggage tag identifiers and corresponding passengers can be sent by the baggage management system to the TC computing system. This table can then be used by the TC computing system to update all of the data structures corresponding to the different passengers to indicate that their bags were checked in.

An example of batch processing of a check-in notification is shown in FIG. 9. Box 901 illustrates a check-in notification sent from an assistant computing device to the baggage management system that includes multiple different baggage tag identifiers. This check-in notification is processed by the baggage management system to determine a passenger identifier corresponding to each baggage tag identifier, as shown in table 902 and discussed above. Each baggage tag identifier and passenger identifier pair is then packaged as a separate baggage update (903A-903E) and sent in a single communication 903 to the TC computing system. This communication 903 would then cause the TC computing system to perform updates to five data structures to indicate that the five bags identified by the baggage tag identifiers were checked in.

Of course, the batch processing can be streamlined further, depending on the operations that are performed by a particular TC computing system. For example, the plurality of baggage tag identifiers (or baggage tags) received from the assistant computing device in the check-in notification can be forwarded by the baggage management system directly to the TC computing system. The TC computing system can then perform the lookup operations described above to update the relevant data structures.

Alternatively, the check-in notification can contain only the passenger identifiers of passengers whose bags have been checked in, along with a message or variable indicating successful check-in. The baggage management system or the TC computing system can then utilize this message or variable along with the received passenger identifiers to look up all corresponding baggage tags and update the internal data structures on the TC computing system to indicate that the bags have been checked in.

As discussed above, the disclosed baggage management system enables early pickup and check-in of baggage independent of the passenger's participation through the use of specialized APIs configured to interface with TC computing systems. Upon the passenger's arrival at a particular destination, these specialized APIs are then used again to update the TC computing system to indicate successful retrieval of the baggage by the passenger.

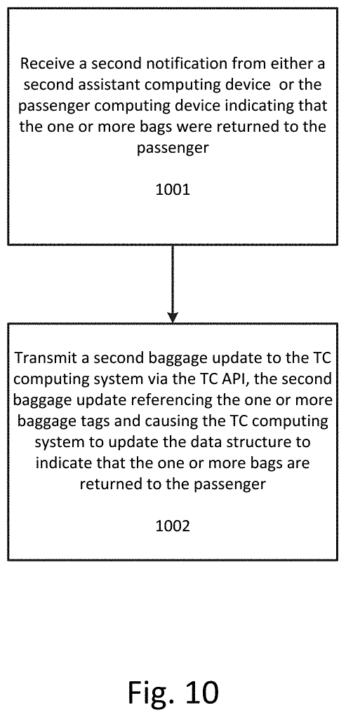

FIG. 10 illustrates a flowchart for processing baggage retrieval according to an exemplary embodiment. At step 1001 a second notification is received from either a second assistant computing device or a passenger computing device indicating that one or more bags were returned to a passenger.

The second assistant can be an assistant stationed at the passenger's destination, such as at the baggage claim area or in an intermediate location between the transportation vehicle and the baggage claim area. For example, in the airline context, the second assistant can review incoming bags after they are deplaned but prior to transport to the baggage claim area. The second assistant can then send a second notification for any bags belonging to a passenger that is a customer of the baggage management system indicating that the bags arrived successfully at their location and will be returned to the corresponding passengers. Similar to the check-in notification, this second notification can include baggage tag identifier, baggage tag images, passenger identifiers, or any other information that enables the baggage management system or the TC computing system to locate and update the appropriate data structures. Similar to the check-in notification, the second notifications indicating successful arrival of the bags can also be batched and transmitted in a single message.

Alternatively, the second assistant can be stationed at the baggage claim area. When passengers who are customers of the baggage management system retrieve their bags from baggage claim area, the second assistant can transmit the corresponding second notification to the baggage management system.

As shown in step 1001, the second notification can also be received directly from the passenger computing device. In this case, the passenger can retrieve their bags at the destination baggage claim area and send a notification through an application on the passenger computing device informing the baggage management system that they have successfully retrieved their baggage. The passenger's notification can including identifying information of the passenger, such as their telephone number, name, or passenger identifier, and/or a baggage tag or baggage tag identifier.

If the second notification is transmitted by an assistant at the destination from an assistant computing device, the assistant can also retrieve any location tracking devices that were previously affixed to the baggage for collection and reuse on subsequent trips/baggage. For example, the assistant can collect the location tracking devices affixed to the baggage when stationed at the baggage claim area prior to transmitting the second notification.

If the second notification is transmitted by a passenger upon successful receipt of the baggage, the passenger can deposit any location tracking device at an appropriate return area. For example, the passenger can remove and deposit the device at a collection bin located at the baggage claim area for customers of the baggage management system.

At step 1002 a second baggage update is transmitted by the baggage management system to the TC computing system via the TC API. Similar to the first baggage update, the second baggage update can reference the one or more baggage tags corresponding to the one or more bags of the passenger. The second baggage update then causes the TC computing system to update the corresponding internal data structure to indicate that the one or more bags of the passenger have been returned to the passenger. This is similar to the process used to update the data structure upon baggage check-in described with respect to FIGS. 6A-6E and 7.

As discussed earlier, the baggage management system disclosed herein enables live location tracking of passenger bags within the system through the use of location tracking devices affixed to bags by assistants upon pickup. As shown in FIG. 6D, this tracking utilizes serial numbers or other identifiers of the location tracking device that are provided to the baggage management system by assistants upon pickup. Using the serial numbers or other identifiers, the baggage management system is able to provide location updates to both passengers and to TCs that wish to retrieve current location information for baggage.

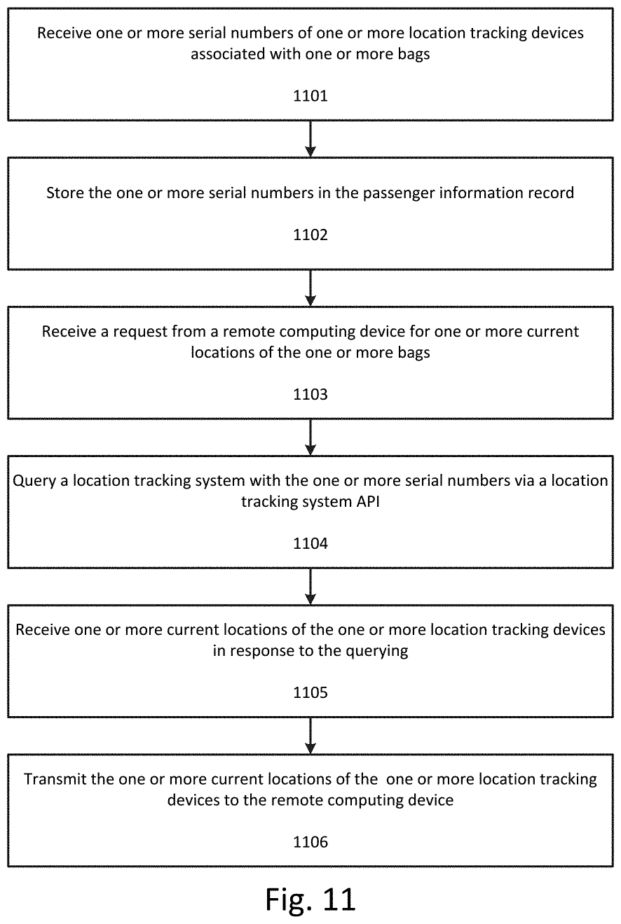

FIG. 11 illustrates a flowchart for location tracking of baggage by the baggage management system according to an exemplary embodiment. At step 1101 one or more serial numbers of one or more location tracking devices associated with the one or more bags are received. As discussed above, these serial numbers (or other identifiers) are received from the assistant computing device of the assistant during baggage pickup.

At step 1102 the one or more serial numbers are stored in the passenger information record for the corresponding passenger. The serial numbers are then leveraged to provide current location information pertaining to the passengers bags. The serial numbers can be linked within the passenger information record to specific bags, baggage tags, or baggage tag identifiers. Alternatively, the serial numbers can be linked to passenger identifiers.

At step 1103 a request is received from a remote computing device for one or more current locations of the one or more bags. The remote computing device can be, for example, a passenger computing device or an assistant computing device. The remote computing device can also be a computing device on the TC computing system. For example, airlines can leverage the baggage management system as a complement or replacement for their own internal baggage tracking systems. The request for current locations can include information sufficient to identify the bags or the passenger, such as the passenger identifier, the baggage tags, or the baggage tag identifiers. The baggage management system is then able to retrieve the serial numbers corresponding to the passenger/baggage tags/baggage tag identifiers by performing a lookup using the passenger information records.

At step 1104 a query is transmitted to a location tracking system with the one or more serial numbers via a location tracking system API. The location tracking API allows the baggage management system to interface with a location tracking computing system (such as a third-party system) in order to retrieve current location information.

At step 1105 one or more current locations of the one or more location tracking devices are received in response to the query. The location tracking system can receive the serial numbers of the location tracking devices and return the coordinates (latitude and longitude) of each location tracking device to the baggage management system.

At step 1106 the one or more current locations of the one or more location tracking devices are transmitted to the remote computing device in response to the request received in step 1103. The current locations can be transmitted within an interface, such as a map interface, plotting the coordinates on a map. For example, if the request is received from a passenger, then a map interface can be displayed on the passenger application, with the baggage being represented by icons on the map interface.

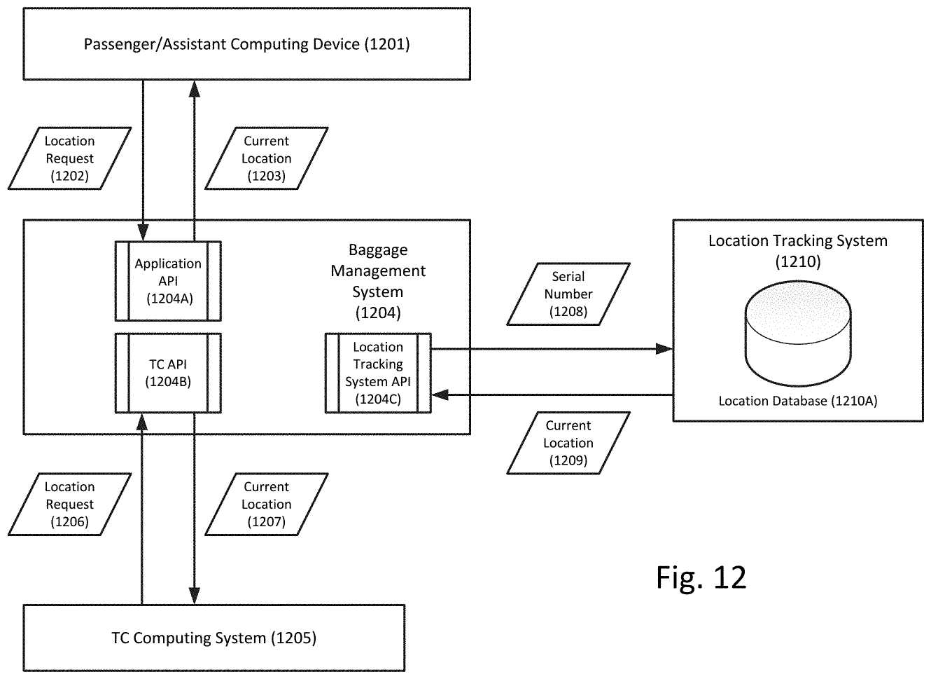

FIG. 12 illustrates a data flow diagram of the process for querying baggage location according to an exemplary embodiment. As shown in FIG. 12, a passenger or assistant computing device 1201 can transmit a location request 1202 to the baggage management system 1204. Location request 1202 is received and processed by an application API 1204A (which can be the passenger application API or the assistant application API).

Similarly, the TC computing system 1205 can also transmit a location request 1206 to the baggage management system 1204. In this case, the location request 1206 is received and processed by the TC API 1204B.

The location requests 1202 and 1206 can include identifying information of the passenger and/or the bags for which the location information is desired. For example, the location requests 1202 and 1206 can include a passenger name and trip number, a passenger identifier, a baggage tag, and/or a baggage tag identifier.

Based on the information in the request, the baggage management system 1204 determines the serial number 1208 of the location tracking devices that are affixed to the bags referenced in the location request 1202. This step can be performed by searching or querying the passenger information records or another similar database stored on the baggage management system.

The baggage management system 1204 then queries location tracking system 1210 with the determined serial numbers 1208. The location tracking system can search a location database 1210A that stores the current coordinates of each location tracking device using the serial numbers as a search key to determine the current location of the requested location tracking devices. Alternatively, the location database 1210A can be omitted and the location tracking system 1210 can communicate directly with the location tracking devices corresponding to the received serial numbers. For example, the location tracking system 1210 can send a request to the location tracking devices corresponding to the received serial numbers to return their current coordinates.

Regardless of how the current location of the location tracking devices is determined, the current location values 1209 are returned to the baggage management system 1204. The baggage management system 1204 can then transmit current location values 1203 to the passenger/assistant computing device 1201 when the initial request was received from the passenger/assistant computing device 1201. Alternatively or additionally, the baggage management system 1204 can transmit current location values 1207 to the TC computing system 1205 in response to a request from that system.

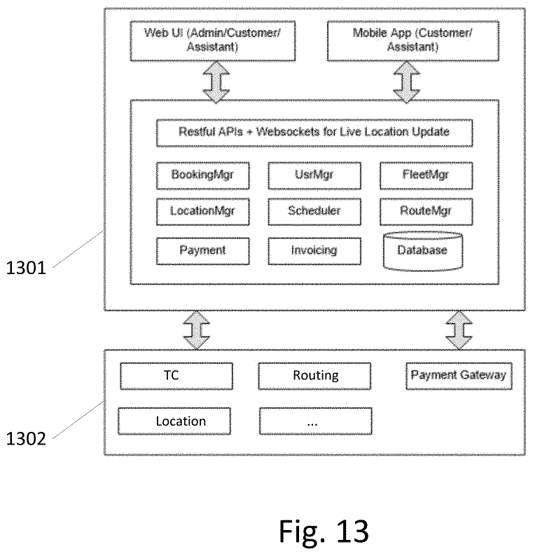

FIG. 13 illustrates a baggage management system 1301 for management and tracking of baggage on an external TC computing system according to an exemplary embodiment. System can be implemented in a variety of different configurations, such as, for example, a scalable cloud based architecture.

System 1301 can include a customer (passenger) and assistant mobile application. The mobile application is developed for customers and assistants and can provide different functionality to customers and assistants, depending on the user role. Of course, the mobile application can have a corresponding desktop application and/or be implemented as part of a website or applet accessible through a web browser.

Customer Mobile Application

When a customer/passenger is using the mobile application, the mobile application can include functionality and interfaces for registration, login, making bookings, tracking baggage, viewing previous bookings, favorites, and/or help/FAQ. These are described in greater detail below.

Registration

The first time user can register with the baggage management system using this interface with his/her mobile number. The user can be authenticated and registered by the platform by, for example, entering a password sent to their mobile device.

Login

This interface allows users to login in to the baggage management system. The application can optionally remember the user's credentials.

Booking Interface

Once the user is logged in, the user can navigate to a booking interface. The user can then enter their identifying information (such as their passenger identifier and/or last name and flight number) to initiate the baggage pickup booking. Once the details of the travel are retrieved by the platform, it shall ask user to confirm the details and proceed to baggage booking.

The user's pickup address can be detected using the GPS location of their mobile device automatically and the user is also able change the pickup address. The user can also designate the detected address or user provided address as a favorite pickup location.

The user's departure airport is picked from the details retrieved based on the passenger identifier. The platform checks whether the service is possible based on the pick-up address and departure airport address. If the service is not available then the appropriate message is displayed to the user. Finally, the user is able to enter a pickup up time or window and the particulars of the baggage (number of bags, size, weight, etc.).

Track Baggage Interface

This interface allows users to check the status of baggage, i.e., booked, route confirmed, in-transit, checked-in, etc. Users can also view the details of booking on this screen i.e. pick-up and destination address, baggage details and invoice

User can also change the pick-up address and baggage details from this screen. Based on the changes the excess amount is charged again from user. In case amount is less the same is credited to his account through which he has made the payment.

Once the route is confirmed by the platform, the user can be notified via push notification, email, and/or SMS. The fleet details and assistant details (such as the assistant's mobile number) are also provided to the user and accessible through the application.

When pickup assistant comes to collect the baggage, he can provide a 6 digit number to customer. The customer can then enter this number on this screen to confirm the identity of assistant.

The user can also check the route used to carry his baggage to the airport and once baggage is in transit he can also track the location of baggage.

Digital baggage tags are issued to the user through this interface and can be provided to the user as push notifications as well through other communications channels, such as email and SMS.

Assistant Mobile Application

When the mobile application is utilized by an assistant, the application can provide interfaces and functionality for indicating active hours (on duty settings), trip assignments, start location and pickup addresses, baggage tag retrieval and access, and history of assignments.

Web User Interface

The platform additionally includes a web user interface (UI) for administrators. This web UI allows administrators to register/remove/edit assistants in the system, along with their vehicle details, determine available routes, and/or generate reports.

The baggage management system 1301 includes various specialized software components used to carry out the methods described herein. These are described in greater detail below.

A User Manager component registers users i.e. customers, assistants and admins into the platform. Once the user is registered, they can use the service provided as per his role by the platform. This module provides user to change his password and also create new password in case user has forgotten his password. Following roles are supported:

A Booking Manager component allows users to create new booking for luggage pickup by creating a booking entry in the database against the user. This component can interface with TC APIs to retrieve the details of user based on provided identification information. This component also sends confirmation of booking to user by email/sms, invokes a scheduler API to schedule the booking, invokes a payment manager for payments, invokes invoicing to generate bills and send bills, notifies users about the booking time by email/SMS and push notification, presents and transmits baggage tags, and allows users to check status of and/or modify bookings.

A Fleet Manager component allows admins to add/edit the trucks and driver details, keep track of the available drivers and trucks for duty, and assign the trips to drivers/trucks.

A Route Manager component manages the locations where service is provided by the platform and interfaces with third party systems for the route optimization.

A Location Manager component interfaces with third part Geolocation devices to receive the location of fleet and provides APIs to mobile apps to check the current location of fleet.

A Payment component manages the user's payment methods and interfaces with a Payment Gateway to receive the payments.

A Scheduler component provides the API to the booking manager to schedule a booking within a particular time window. The scheduler can periodically checks the bookings available for scheduling. At the start of a slot, the scheduler can pick all the bookings for scheduling and call the route manger APIs for optimized route determination. The scheduler can also inform the fleet manager to schedule the fleet on the selected route. Once the user's booking is scheduled and fleet is selected, the scheduler can inform the booking manager, which further notifies the pickup time to user

An invoicing component is responsible for generating the invoice and keeps the history of user's invoice for future download.

The baggage management system includes APIs for interfacing with several external components 1302 over a computer network. These include the TC computing system, routing optimization systems, location tracking systems, payment gateways, and any other external components used to provide information to passengers or assistants.

The baggage management system 1301 can be implemented using a variety of different hardware infrastructures, and includes a memory that is a non-transitory computer-readable medium and can be volatile memory (e.g., registers, cache, RAM), non-volatile memory (e.g., ROM, EEPROM, flash memory, etc.), or some combination of the two. The memory can store the software components discussed above. All of the software stored within memory can be stored as a computer-readable instructions, that when executed by one or more processors, cause the processors to perform the functionality described in this application.

Baggage management system 1301 also includes processors. The processors execute computer-executable instructions and can be a real or virtual processors. In a multi-processing system, multiple processors or multicore processors can be used to execute computer-executable instructions to increase processing power and/or to execute certain software in parallel.

Baggage management system 1301 also include a communication interfaces, such as a network interface, which are used to monitor devices on a network and communicate with devices on a computer network. The communication interfaces convey information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The baggage management system 1301 further includes input and output interfaces that allow passengers, administrators, TCs, and others to provide input to the system and display or otherwise transmit information for display to users. Input and output interfaces can be coupled to input and output devices. The input device(s) can be a touch input device such as a keyboard, mouse, pen, trackball, touch screen, or game controller, a voice input device, a scanning device, a digital camera, remote control, or another device that provides input to the computing environment. The output device(s) can be a display, television, monitor, printer, speaker, or another device that provides output from the computing environment.

An interconnection mechanism, such as a bus, controller, or network can interconnect the various hardware components of the baggage management system.

The baggage management platform can additionally utilize a removable or non-removable storage, such as magnetic disks, magnetic tapes or cassettes, CD-ROMs, CD-RWs, DVDs, USB drives, or any other medium which can be used to store information and which can be accessed within the computing environment.

The baggage management system computing environment can be, for example, a set-top box, personal computer, a client device, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

We claim:

1. A method executed by a computing system external to a transportation carrier (TC) computing system for management and tracking of baggage on the TC computing system, the method comprising:
storing, by the computing system, a passenger information record, the passenger information record comprising a passenger identifier generated by the TC computing system, the passenger identifier corresponding to a passenger of the TC;
transmitting, by the computing system, a request for baggage tags to a transportation carrier (TC) computing system via a TC Application Programming Interface (API), the request comprising the passenger identifier;
receiving, by the computing system, in response to the request, one or more baggage tags from the TC computing system via the TC API, the one or more baggage tags corresponding to one or more bags of the passenger and being linked to the passenger identifier in a data structure of the TC computing system;
transmitting, by the computing system, the one or more baggage tags to an assistant computing device;
receiving, by the computing system, a check-in notification from the assistant computing device indicating that the one or more bags were checked in with the TC; and
transmitting, by the computing system, a baggage update to the TC computing system via the TC API, the baggage update referencing the one or more baggage tags and causing the TC computing system to update the data structure to indicate that the one or more bags are checked in.

2. The method of claim 1, further comprising:
receiving, by the computing system, a second notification from either a second assistant computing device or the passenger computing device indicating that the one or more bags were returned to the passenger; and
transmitting, by the computing system, a second baggage update to the TC computing system via the TC API, the second baggage update referencing the one or more baggage tags and causing the TC computing system to update the data structure to indicate that the one or more bags are returned to the passenger.

3. The method of claim 1, further comprising:
receiving, by the computing system, one or more serial numbers of one or more location tracking devices associated with the one or more bags;
storing, by the computing system, the one or more serial numbers in the passenger information record;
receiving, by the computing system, a request from a remote computing device for one or more current locations of the one or more bags;
transmitting, by the computing system, a query to a location tracking system with the one or more serial numbers via a location tracking system API;
receiving, by the computing system, one or more current locations of the one or more location tracking devices in response to the query; and
transmitting, by the computing system, the one or more current locations of the one or more location tracking devices to the remote computing device.

4. The method of claim 1, wherein storing a passenger information record comprises:
receiving, by the computing system, passenger identification information from a passenger computing device, the passenger identification information comprising a passenger name and trip number;
transmitting, by the computing system, a passenger information query to the TC computing system via the TC API, the passenger information query comprising the passenger name and trip number;
receiving, by the computing system, the passenger identifier from the TC computing system via the TC API in response to the passenger information query; and
storing, by the computing system, the passenger name, trip number, and passenger identifier in the passenger information record.

5. The method of claim 1, wherein the check-in notification indicates that a plurality of bags associated with a plurality of passengers were checked in and wherein transmitting a baggage update to the TC computing system via the TC API comprises:
identifying a passenger associated with each bag in the plurality of bags; and
transmitting a plurality of baggage updates to the TC computing system via the TC API, each baggage update referencing one or more baggage tags of one or more bags in the plurality of bags and including a passenger identifier of a passenger associated with the one or more bags.

6. The method of claim 1, wherein the TC comprises one or more of: an airline, a bus, a cruise ship, or a railroad.

7. The method of claim 1, further comprising:
receiving, by the computing system, a TC identifier from a passenger computing device; and
selecting, by the computing system, the TC API for communications with the TC from a plurality of TC APIs based at least in part on the received TC identifier.

8. An apparatus external to a transportation carrier (TC) computing system for management and tracking of baggage on the TC computing system, the apparatus comprising:
one or more processors; and
one or more memories operatively coupled to at least one of the one or more processors and having instructions stored thereon that, when executed by at least one of the one or more processors, cause at least one of the one or more processors to:
store a passenger information record, the passenger information record comprising a passenger identifier generated by the TC computing system, the passenger identifier corresponding to a passenger of the TC;
transmit a request for baggage tags to a transportation carrier (TC) computing system via a TC Application Programming Interface (API), the request comprising the passenger identifier;
receive, in response to the request, one or more baggage tags from the TC computing system via the TC API, the one or more baggage tags corresponding to one or more bags of the passenger and being linked to the passenger identifier in a data structure of the TC computing system;
transmit the one or more baggage tags to an assistant computing device;
receive a check-in notification from the assistant computing device indicating that the one or more bags were checked in with the TC; and
transmit a baggage update to the TC computing system via the TC API, the baggage update referencing the one or more baggage tags and causing the TC computing system to update the data structure to indicate that the one or more bags are checked in.

9. The apparatus of claim 8, wherein at least one of the one or more memories has further instructions stored thereon that, when executed by at least one of the one or more processors, cause at least one of the one or more processors to:
receive a second notification from either a second assistant computing device or the passenger computing device indicating that the one or more bags were returned to the passenger; and
transmit a second baggage update to the TC computing system via the TC API, the second baggage update referencing the one or more baggage tags and causing the TC computing system to update the data structure to indicate that the one or more bags are returned to the passenger.

10. The apparatus of claim 8, wherein at least one of the one or more memories has further instructions stored thereon that, when executed by at least one of the one or more processors, cause at least one of the one or more processors to:
receive one or more serial numbers of one or more location tracking devices associated with the one or more bags;
store the one or more serial numbers in the passenger information record;
receive a request from a remote computing device for one or more current locations of the one or more bags;
transmit a query to a location tracking system with the one or more serial numbers via a location tracking system API;
receive one or more current locations of the one or more location tracking devices in response to the query; and
transmit the one or more current locations of the one or more location tracking devices to the remote computing device.

11. The apparatus of claim 8, wherein the instructions that, when executed by at least one of the one or more processors, cause at least one of the one or more processors to store a passenger information record further cause at least one of the one or more processors to:
receive passenger identification information from a passenger computing device, the passenger identification information comprising a passenger name and trip number;
transmit a passenger information query to the TC computing system via the TC API, the passenger information query comprising the passenger name and trip number;
receive the passenger identifier from the TC computing system via the TC API in response to the passenger information query; and
store the passenger name, trip number, and passenger identifier in the passenger information record.

12. The apparatus of claim 8, wherein the check-in notification indicates that a plurality of bags associated with a plurality of passengers were checked in and wherein the instructions that, when executed by at least one of the one or more processors, cause at least one of the one or more processors to transmit a baggage update to the TC computing system via the TC API further cause at least one of the one or more processors to:
identify a passenger associated with each bag in the plurality of bags; and
transmit a plurality of baggage updates to the TC computing system via the TC API, each baggage update referencing one or more baggage tags of one or more bags in the plurality of bags and including a passenger identifier of a passenger associated with the one or more bags.

13. The apparatus of claim 8, wherein the TC comprises one or more of: an airline, a bus, a cruise ship, or a railroad.

14. The apparatus of claim 8, wherein at least one of the one or more memories has further instructions stored thereon that, when executed by at least one of the one or more processors, cause at least one of the one or more processors to:
receive a TC identifier from a passenger computing device; and
select the TC API for communications with the TC from a plurality of TC APIs based at least in part on the received TC identifier.

15. At least one non-transitory computer-readable medium storing computer-readable instructions that, when executed by one or more computing devices, cause at least one of the one or more computing devices to:
store a passenger information record, the passenger information record comprising a passenger identifier generated by a transportation carrier (TC) computing system, the passenger identifier corresponding to a passenger of the TC;
transmit a request for baggage tags to a transportation carrier (TC) computing system via a TC Application Programming Interface (API), the request comprising the passenger identifier;
receive, in response to the request, one or more baggage tags from the TC computing system via the TC API, the one or more baggage tags corresponding to one or more bags of the passenger and being linked to the passenger identifier in a data structure of the TC computing system;
transmit the one or more baggage tags to an assistant computing device;
receive a check-in notification from the assistant computing device indicating that the one or more bags were checked in with the TC; and
transmit a baggage update to the TC computing system via the TC API, the baggage update referencing the one or more baggage tags and causing the TC computing system to update the data structure to indicate that the one or more bags are checked in.

16. The at least one non-transitory computer-readable medium of claim 15, further storing computer-readable instructions that, when executed by at least one of the one or more computing devices, cause at least one of the one or more computing devices to:
receive a second notification from either a second assistant computing device or the passenger computing device indicating that the one or more bags were returned to the passenger; and
transmit a second baggage update to the TC computing system via the TC API, the second baggage update referencing the one or more baggage tags and causing the TC computing system to update the data structure to indicate that the one or more bags are returned to the passenger.

17. The at least one non-transitory computer-readable medium of claim 15, further storing computer-readable instructions that, when executed by at least one of the one or more computing devices, cause at least one of the one or more computing devices to:
receive one or more serial numbers of one or more location tracking devices associated with the one or more bags;
store the one or more serial numbers in the passenger information record;
receive a request from a remote computing device for one or more current locations of the one or more bags;
transmit a query to a location tracking system with the one or more serial numbers via a location tracking system API;
receive one or more current locations of the one or more location tracking devices in response to the query; and
transmit the one or more current locations of the one or more location tracking devices to the remote computing device.

18. The at least one non-transitory computer-readable medium of claim 15, wherein the instructions that, when executed by at least one of the one or more computing devices, cause at least one of the one or more computing devices to store a passenger information record further cause at least one of the one or more computing devices to:
receive passenger identification information from a passenger computing device, the passenger identification information comprising a passenger name and trip number;
transmit a passenger information query to the TC computing system via the TC API, the passenger information query comprising the passenger name and trip number;
receive the passenger identifier from the TC computing system via the TC API in response to the passenger information query; and
store the passenger name, trip number, and passenger identifier in the passenger information record.

19. The at least one non-transitory computer-readable medium of claim 15, wherein the check-in notification indicates that a plurality of bags associated with a plurality of passengers were checked in and wherein the instructions that, when executed by at least one of the one or more computing devices, cause at least one of the one or more computing devices to transmit a baggage update to the TC computing system via the TC API further cause at least one of the one or more computing devices to:
identify a passenger associated with each bag in the plurality of bags; and
transmit a plurality of baggage updates to the TC computing system via the TC API, each baggage update referencing one or more baggage tags of one or more bags in the plurality of bags and including a passenger identifier of a passenger associated with the one or more bags.

20. The at least one non-transitory computer-readable medium of claim 15, wherein the TC comprises one or more of: an airline, a bus, a cruise ship, or a railroad.

21. The at least one non-transitory computer-readable medium of claim 15, further storing computer-readable instructions that, when executed by at least one of the one or more computing devices, cause at least one of the one or more computing devices to:
receive a TC identifier from a passenger computing device; and
select the TC API for communications with the TC from a plurality of TC APIs based at least in part on the received TC identifier.
